(19) United States
(12) Patent Application Publication
(10) Pub. No.: US 2008/0313094 A1
(43) Pub. Date: Dec. 18, 2008

(54) METHOD AND SYSTEM FOR SEARCHING, DISPLAYING AND SORTING PRODUCTS OR SERVICES ACCORDING TO COMPUTED COSTS

(75) Inventor: Charles P. Wright, Cortlandt Manor, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/761,622

(22) Filed: Jun. 12, 2007

(51) Int. Cl. G06Q 40/00

(52) U.S. Cl. 705/36 R

(57) ABSTRACT

A method and system are disclosed for searching, displaying and sorting products or services according to computed costs for the products or services per a specified time period. For each of a group of products or services, (i) a first component cost is determined representing the cost of purchasing or leasing the product or service per a specified time period, (ii) a second component cost is determined representing the cost of owning the product or using the service per said specified time period. These component costs are added to obtain a total cost of purchase or lease and ownership or use. Users are provided with an interface to a computer system that enables the users to display, search and sort said group of products or services according to said total cost per said specified time period.

### BACKGROUND OF THE INVENTION

1. Field of the Invention

The present invention generally relates to methods and systems for searching, displaying and sorting products or services according to computed costs for the products or services.

2. Background Art

Many products and services have several associated costs of ownership or use, and making an informed decision to buy or not to buy one of these products or services requires analyzing the sum of each of those costs. For example, purchasing real property results in several components contributing to the cost of ownership. When searching for real property, an interface to a multiple listing service is typically used. The user typically may search on several attributes of the property including list price, location, features (e.g., bedrooms or lot size), and amenities and sort the results by increasing or decreasing list price as shown in FIG. 1. One of the most important factors when evaluating whether it is worthwhile to visit or make an offer on a property is of course is the list price, but unfortunately, the list price is not necessarily a good indicator of the total cost of ownership, which includes mortgage payments (principle and interest), taxes, hazard insurance, flood insurance, mortgage insurance, homeowners association fees, maintenance, common charges, and more. Moreover, some of these components can vary widely even within the same region and price range.

For example, each $1,000 dollars in yearly property taxes results in an additional monthly payment of $83.33. Thus, of two properties, the property with the taxes that are $1,000 lower could cost $12,525 more (assuming the buyer selects a 30-year fixed mortgage at 7% interest) than the other property; yet the cost of ownership of the two properties would be the same. In some areas of the country, property taxes are a significant cost of ownership and differences of several thousand dollars per year in property taxes for similarly priced properties are not uncommon. This is just one example of how list prices can be misleading when evaluating the cost of a property.

More complicated situations of course arise. For example, when considering both condominiums and single-family homes, the condominium includes a required monthly common charge that the single family home does not. Thus if a condominium costs $500,000 and the single family home costs $600,000, but the condominium has a common charge of $600, the monthly payment for the home would be only $65.30 more per month (again assuming that both properties are financed with 30-year fixed mortgages at 7%). Moreover, mortgage interest and property taxes are often tax deductible, whereas common charges are not. Thus, if the tax savings are included in the calculation, the single family home may result in a lower after-tax cost.

From these examples, it becomes apparent that computing the cost of ownership for a property is a difficult and time consuming task that requires the use of many variables. Fortunately, these variables are included in the typical listing report for a property, as shown in FIG. 2. Thus, automatically computing the cost of ownership is simple using basic addition and well-known formulas. In fact, some listing reports include partial calculators that calculate one component, such as a mortgage payment, and other listing reports include separate links to calculators that include these components. However, these methods still require additional data entry to compute accurate costs of ownership, because they do not take into account more complex loan products or the user's personal situation (e.g., putting the user's down payment into a bank account and expected interest rate, preferred loan product, etc.). Thus, sophisticated users often manually copy values from the listing report into separate spreadsheet software applications in order to obtain an accurate cost of ownership using one or more scenarios.

### SUMMARY OF THE INVENTION

An object of this invention is to provide a method and system for analyzing the costs of products and services that have multiple component and associated ownership or use costs.

Another object of the invention is to provide a user interface to a computer system for locating products or services that have multiple costs associated with ownership and that allows users to display, search, and sort products based on the cost of ownership.

These and other objectives are attained with a method of and system for searching, displaying and sorting products or services according to computed costs for the products or services per a specified time period. The method comprises the steps of establishing the specified time period; and for each of a group of products or services, (i) determining a first component cost representing the cost of purchasing or leasing the product or service per said specified time period when said cost is amortized over a defined time, (ii) determining a second component cost representing the cost of owning the product or using the service per said specified time period, and (iii) adding said first and second component costs to obtain a total cost of purchase or lease and ownership or use per said specified time period. Users are provided with an interface to a computer system that enables the users to display, search and sort said group of products or services according to said total cost of purchase or lease and ownership or use per said specified time period.

In one embodiment of the invention, the products or services include a multitude of houses. In this embodiment, the first component cost includes, for each of the houses, a down payment, a mortgage payment, mortgage insurance, and sale closing costs; and the second component cost includes, for each of the houses, property taxes, homeowners insurance, maintenance, common charges, homeowner's association fees. The mortgage payments are calculated using a given load term, type of loan, expected principle, and interest rate, and the mortgage payments are offset by a saving in income taxes, calculated using a given income tax rate. Also, the second component cost also includes a commuting cost calculated using the locations of the homes.

In a second embodiment, the products and services include a multitude of automobiles. In this embodiment, for some of said automobiles, said first component cost includes retail prices of the automobiles; and for others of said automobiles, said first component cost includes lease payments for the automobiles. In addition, the second component costs include liability insurance, comprehensive insurance, collision insurance, repairs and maintenance.

The preferred embodiment of the invention, described below in detail, provides a user interface in which an accurate cost of ownership is displayed as a first class entity in the listing report, for instance as shown in FIG. 3. Moreover, the cost of ownership can be used as a search criterion and also to rank search results, for example as illustrated in FIG. 4.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 shows an example of a typical search interface for real property.

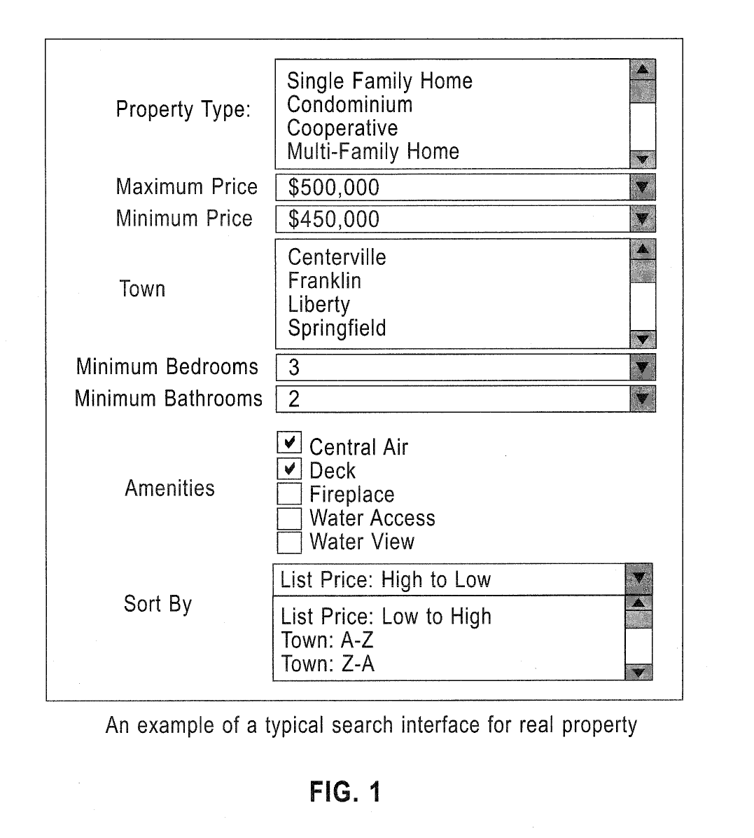

FIG. 2 shows an example of a typical listing report for a house for sale.

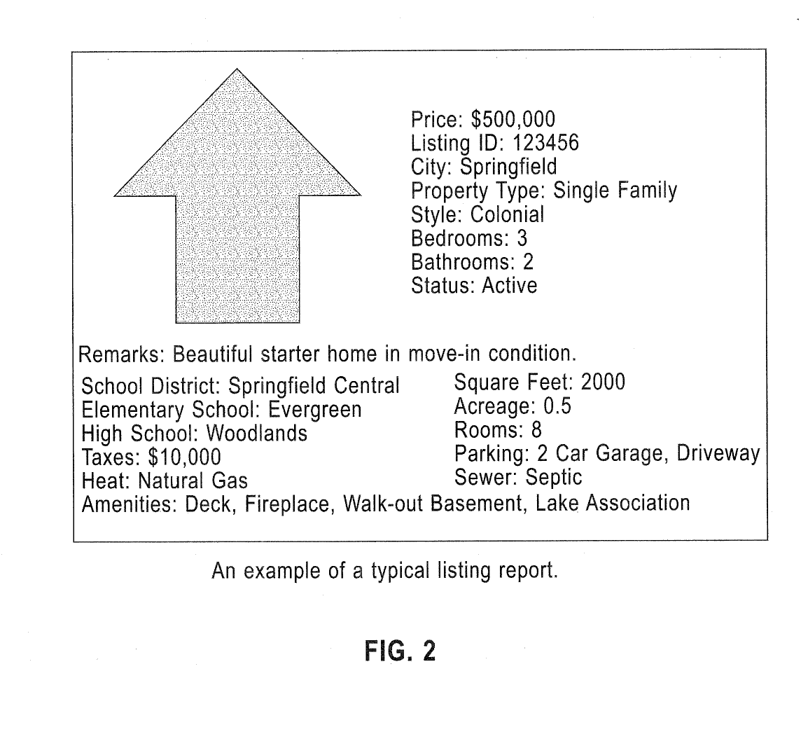

FIG. 3 illustrates an example of an improved listing report prepared in accordance with the present invention.

FIG. 4 shows an example of an improved search interface prepared in accordance with this invention.

FIG. 5 shows an example, prepared in accordance with the present invention, of additional information about a house for sale.

FIG. 6 illustrates an example of a user profile page, prepared according to the present invention.

FIG. 7 shows an example of a listing report including distances to various locations.

FIG. 8 shows a computer system that may be used to carry out this invention.

### DETAILED DESCRIPTION OF THE PREFERRED EMBODIMENTS

The present invention, generally, provides a method and system for analyzing the costs of products and services that have multiple components and associated ownership costs. More specifically, this invention provides a method of and system for searching, displaying and sorting products or services according to computed costs for the products or services per a specified time period. The method comprises the steps of establishing the specified time period; and for each of a group of products or services, (i) determining a first component cost representing the cost of purchasing or leasing the product or service per said specified time period when said cost is amortized over a defined time, (ii) determining a second component cost representing the cost of owning the product or using the service per said specified time period, and (iii) adding said first and second component costs to obtain a total cost of purchase or lease and ownership or use per said specified time period. Users are provided with an interface to a computer system that enables the users to display, search and sort said group of products or services according to said total cost of purchase or lease and ownership or use per said specified time period.

In one embodiment of the invention, the products or services include a multitude of houses. In this embodiment, the first component cost includes, for each of the houses, a down payment, a mortgage payment, mortgage insurance, and sale closing costs; and the second component cost includes, for each of the houses, property taxes, homeowners insurance, maintenance, common charges, and homeowner's association fees. The mortgage payments are calculated using a given loan term, type of loan, expected principle, and interest rate, and the mortgage payments are offset by a saving in income taxes, calculated using a given income tax rate. The second component cost may also include a commuting cost calculated based on the locations of the homes.

In a second embodiment, the products and services include a multitude of automobiles. In this embodiment, for some of said automobiles, said first component cost includes retail prices of the automobiles; and for others of said automobiles, said first component cost includes lease payments for the automobiles. In addition, the second component costs include liability insurance, comprehensive insurance, collision insurance, repairs and maintenance.

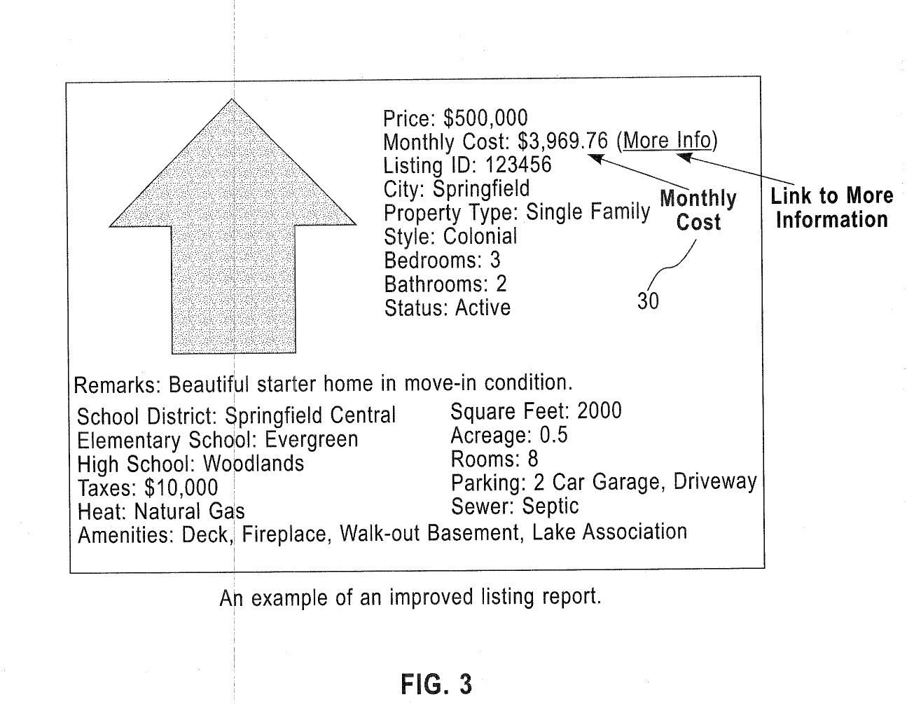

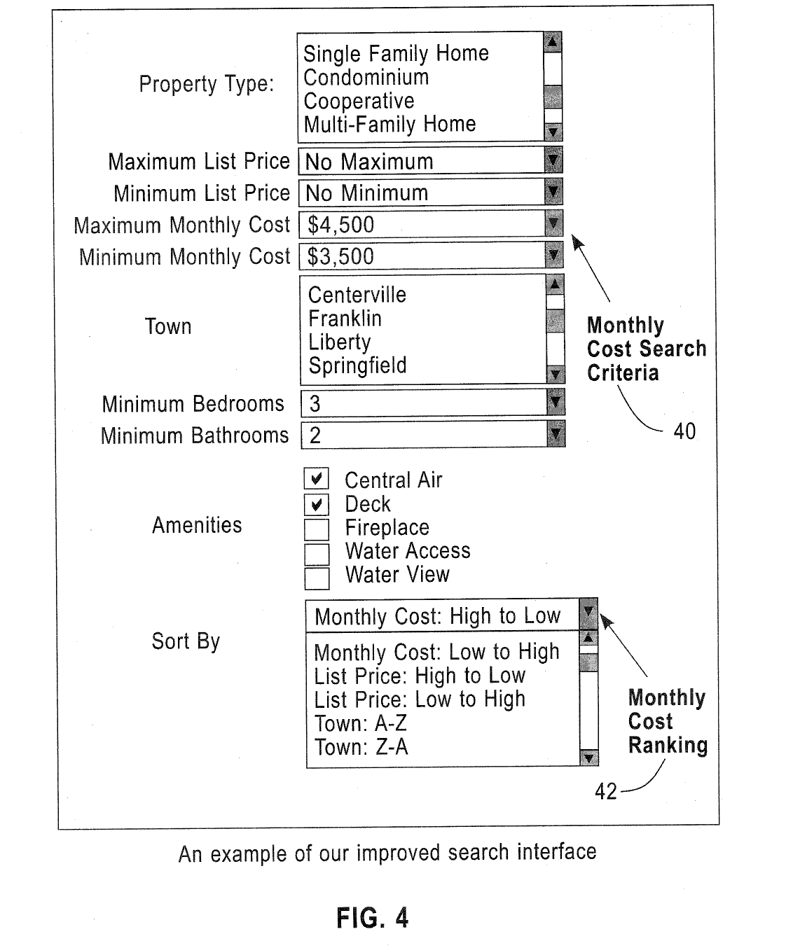

The preferred embodiment of the invention provides a user interface in which an accurate cost of ownership is displayed as a first class entity in the listing report, for instance as shown at 30 in FIG. 3. Moreover, the cost of ownership can be used as a search criterion and also to rank search results, for example as illustrated at 40 and 42 in FIG. 4.

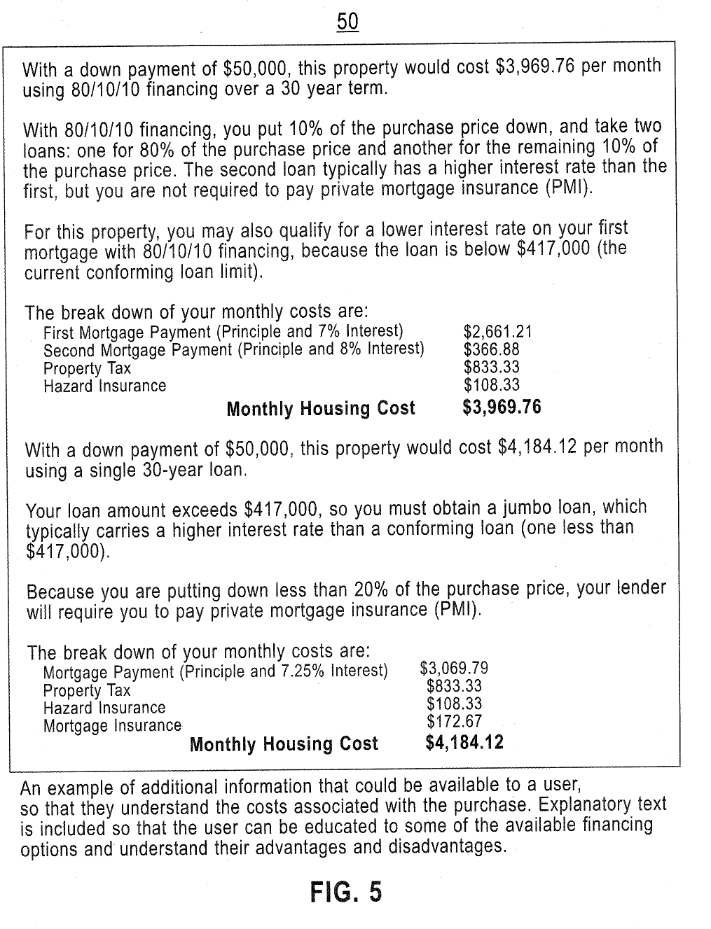

In addition, rather than using a single method of computing the cost of ownership (e.g., a single 30-year fixed mortgage), the preferred embodiment of the invention can compute the cost of ownership using several methods (e.g., a piggyback mortgage vs. paying private mortgage insurance premiums) and uses the best result as the value presented to the user. In addition to the value, the parameters that obtained it are presented and explained to the user, as illustrated, for example at 50, in FIG. 5, thus serving as an educational tool. This is especially important as more and increasingly complex financing options become available to consumers.

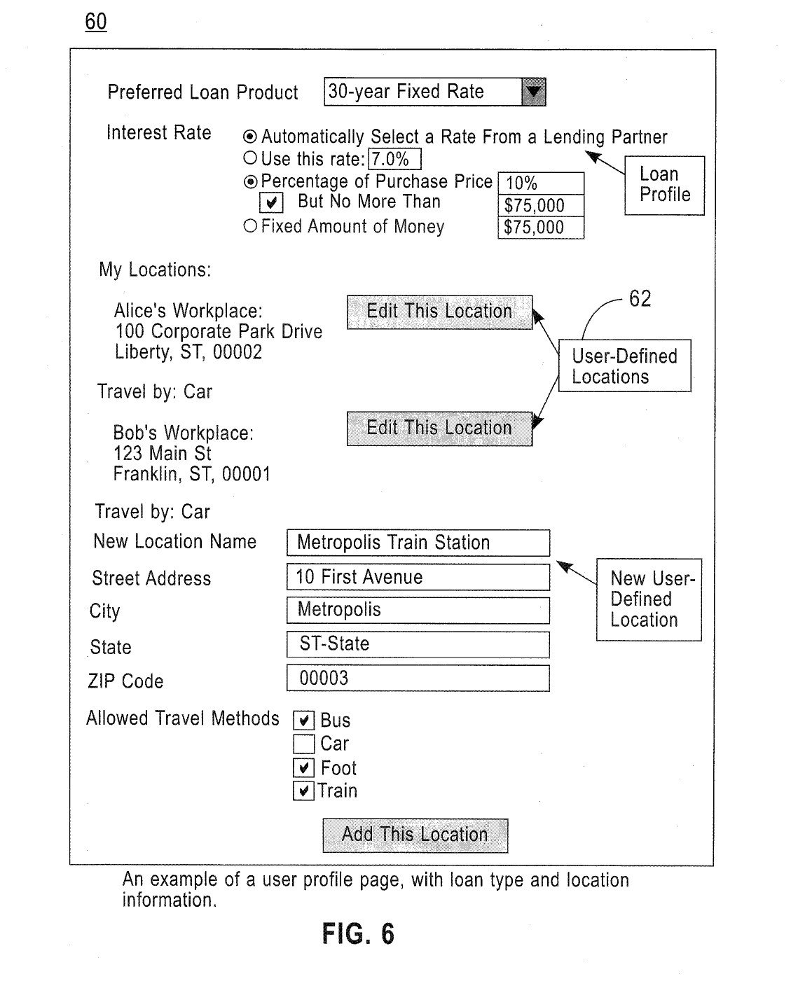

In the absence of a user profile, the preferred system of the present invention can use predetermined values (e.g., based on a conservative approach of a 30-year fixed mortgage or the parameters of a standard affordability index). In addition to the listing information such as listing price, taxes, homeowners association fees, common charges, and maintenance, dynamic inputs to such a model can include current interest rates, estimated insurance costs, and income tax rates. Thus, a user is presented with an estimated monthly cost of ownership even without inputting personal date. To provide a more accurate monthly cost of ownership, personal information such as cash-on-hand, income, monthly budget, preferred loan type, preferred loan term, preferred down payment (as a percentage or absolute value) and other factors can be included in the model, as illustrated at 60 in FIG. 6.

An alternative to purchasing a property is to rent. However, searching for both rental and for sale properties at the same time is difficult because the rental properties are typically listed with a monthly rent, while for sale properties are listed with purchase price and other carrying costs. This makes it difficult to list properties in a similar price range using a single search. The use of a monthly cost of ownership as a first class entity also allows for the comparison between properties for rent and those for sale.

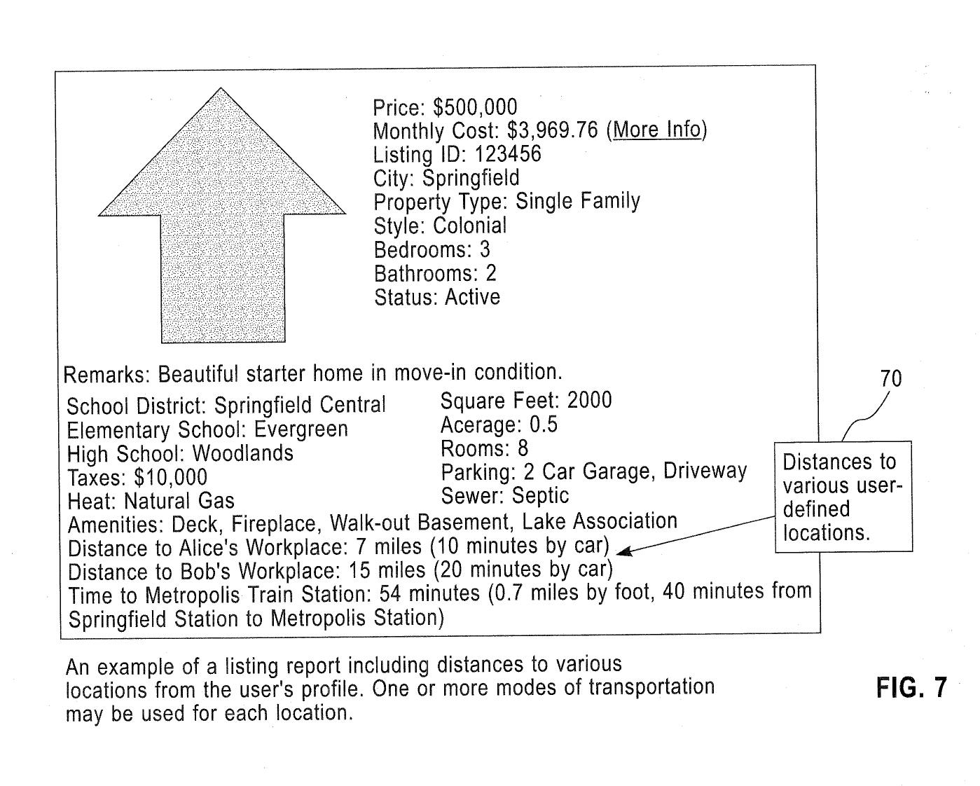

In addition to carrying costs, the monetary cost and time spent commuting or traveling to locations such as work is an important consideration when purchasing a residence. Again, determining the suitability of a property requires additional steps, to obtain directions to various locations using one or more methods of transportation (e.g., driving directions, walking distance, or light rail schedules). In the preferred system if this invention, users can, as shown at 62 in FIG. 6, input one or more locations and weights (e.g., days per week traveled) into their profile; and the distance is displayed in the listing report, as shown at 70 in FIG. 7, and can be used as a search and ranking parameter.

Using the cost of ownership as a first class value that is displayed, can be searched on, and results can be ranked on is not limited to real property. Indeed, any products or service which has multiple costs associated with ownership can use this method for locating products or services. Another example is automobile ownership, which requires a loan (or lease) payment, possibly one or more forms of insurance (e.g., liability, collision, and comprehensive coverage), maintenance, vehicle use taxes, and expected fuel costs. The methods and interfaces described above can easily be applied to this or any other product or service.

As will be readily apparent to those skilled in the art, the present invention, or aspects of the invention, can be realized in hardware, software, or a combination of hardware and software. Any kind of computer/server system(s)—or other apparatus adapted for carrying out methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

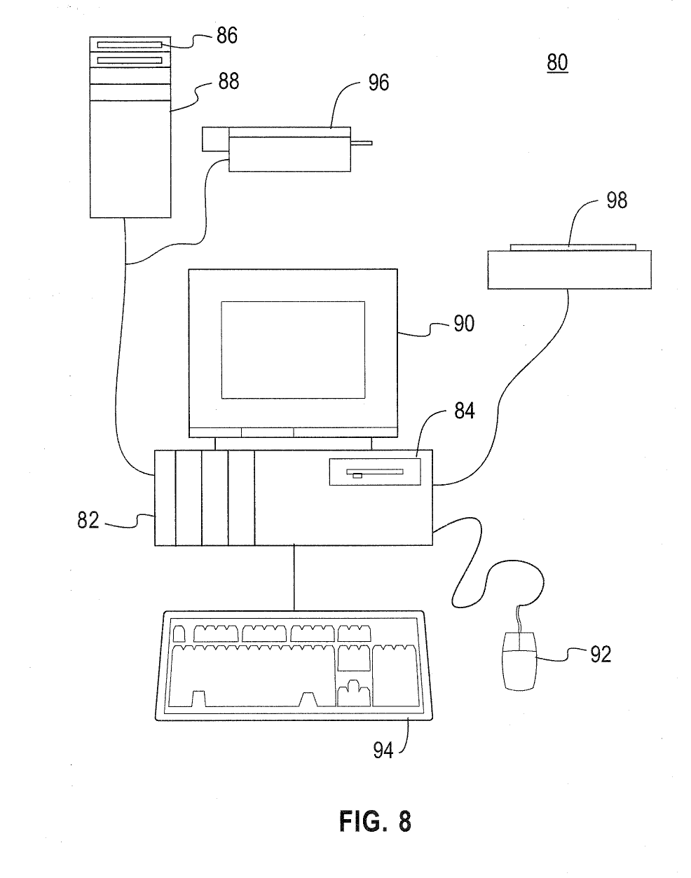

For example, FIG. 8 illustrates a computer system 80 which may be used in the implementation of the present invention may be carried out. Computer system 80 includes a processing unit 82 that houses a processor, memory and other systems components that implement a general purpose processing system that may execute a computer program product comprising media, for example a floppy disc that may be read by processing unit 82 through floppy drive 84.

The program product may also be stored on hard disk drives within processing unit 82 or may be located on a remote system 86 such as a server 88, coupled to processing unit 82, via a network interface, such as an Ethernet interface. Monitor 90, mouse 92 and keyboard 94 are coupled to processing unit 82, to provide user interaction. Scanner 98 and printer 98 are provided for document input and output. Printer 98 is shown coupled to processing unit 82 via a network connection, but may be coupled directly to the processing unit. Scanner 96 is shown coupled to processing unit 82 directly, but it should be understood that peripherals may be network coupled or direct coupled without affecting the ability of workstation computer 80 to perform the method of, or aspects of, the invention.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of searching, displaying and sorting products or services according to computed costs for the products or services per a specified time period, the method comprising the steps of:
establishing the specified time period;
for each of a group of products or services;
determining a first component cost representing the cost of purchasing or leasing the product or service per said specified time period when said cost is amortized over a defined time;
determining a second component cost representing the cost of owning the product or using the service per said specified time period;
adding said first and second component costs to obtain a total cost of purchase or lease and ownership or use per said specified time period; and
providing users with an interface to a computer system that enables the users to display, search and sort said group of products or services according to said total cost of purchase or lease and ownership or use per said specified time period.

2. A method according to claim 1, wherein said products or services include a multitude of houses, and wherein:
said first component cost includes, for each of the houses, a down payment, a mortgage payment, mortgage insurance, and sale closing costs;
said second component cost includes, for each of the houses, property taxes, homeowners insurance, maintenance, common charges, homeowner's association fees;
said mortgage payments are calculated using a given load term, type of loan, expected principle, and interest rate;
said mortgage payments are offset by a saving in income taxes, calculated using a given income tax rate; and
said second component cost also includes a commuting cost calculated using the locations of the homes.

3. A method according to claim 1, wherein said products and services include a multitude of automobiles, and wherein:
for some of said automobiles, said first component cost includes retail prices of the automobiles; and for others of said automobiles, said first component cost includes lease payments for the automobiles; and
said second component costs include liability insurance, comprehensive insurance, collision insurance, repairs and maintenance.

4. A method according to claim 1, wherein:
the step of determining the first component cost includes the step of determining a plurality of first component costs using a first set of cost estimates and assumptions;
the step of determining the second component cost includes the step of determining a plurality of second component costs using a second set of cost estimates and assumptions;
the step of adding said first and second component costs includes the step of obtaining a plurality of total costs of purchase or lease and ownership or use, from said plurality of said first component costs and said plurality of second component costs; and
the providing step includes the step of displaying to the user the minimum of said plurality of total costs.
